(19) United States
(12) Patent Application Publication
(10) Pub. No.: US 2004/0051011 A1
(43) Pub. Date: Mar. 18, 2004

(54) Adjustable support trestle

(76) Inventor: Klemens Degen, Weibern (DE)

Correspondence Address: BELL, BOYD & LLOYD, LLC, PO BOX 1135, CHICAGO, IL, 60690-1135, US

(21) Appl. No.: 10/416,473

(22) PCT Filed: Nov. 7, 2001
(86) PCT No.: PCT/EP01/12868

(30) Foreign Application Priority Data
Nov. 10, 2000 (DE) 10055925.5

(51) Int. Cl. F16M 11/38

(52) U.S. Cl. 248/166

(57) ABSTRACT

The invention relates to a support trestle comprising a base (1 to 5) and a support head (8) mounted thereon, whose height is adjustable, said support head having a support element that is configured as a roller (9) and is used to support workpieces. According to the invention, the support head (8) has at least one additional support element (10, 11) that can be used instead of the roller (9) and that can be brought into an operational position by pivoting the support head (8).

The invention relates to a support trestle having a base and a support head mounted to be height-adjustable on the latter, which support head has a support element which can be used as a workpiece support and is designed as a roller.

Such support trestles are known in the state of the art. The base of the support trestles known in the state of the art consists of a pair of legs. This pair of legs has on the ground side a crossbeam in the form of a transverse support, which has standing feet on the end side. The two legs of the pair of legs may be coupled to one another to be pivotably moveable, so that they may be brought from a parallel position into a stay position. A height-adjustable tube, which supports a support head on the end side, may project from one of the legs. This support head supports a roller, the axis of which lies in the horizontal, so that a workpiece for supporting the same may be placed on the top of the roller.

The object of the invention is to develop such a support trestle to be advantageous in use.

The object is achieved by the invention indicated in the claims.

Claim 1 proposes in particular that the support head has at least one further support element which can be used as a workpiece support instead of the roller. According to the invention, the generic support trestle is designed to be adjustable. Not only the known roller, but also a further support element may act as a workpiece support. In a further development of the invention, provision is made in that the at least one further support element can be brought into its operational position by a pivoting manipulation. The further support element may thus be assigned to a pivoting mount, which can be pivoted from a non-use position lying next to the roller to an operational position lying above the roller. The pivoting mount may lock in its operational position. In a development of the invention, provision may be made in that the pivoting mount forms two support elements, wherein the one support element occupies its operational position in an approximately 90° pivoting position with respect to the roller operational position and the other support element in an approximately 180° pivoting position. A flat bearing surface is particularly suitable as a support element. However, it is also possible to use a row-like arrangement of bearing balls as a support surface. A combination of the two is preferably used, so that in the first pivoting position, the flat bearing surface points upwards, on which a workpiece may be placed, so that it is held there to be secure against rolling. In the other operational position, a row-like arrangement of bearing balls may point upwards. The workpiece may be placed on the top points of the bearing balls, so that it can be displaced in the entire horizontal plane, and does not have a preferred direction as for the roller support. The flat bearing surface may be formed by an angular extension of the sheet metal section supporting the bearing balls of the pivoting mount designed as a punched bent component. The pivoting mount may thus be punched from sheet metal and be brought to the appropriate shape by bending. The pivoting mount may thus have two angular end sections which as a whole stand U-shaped with respect to one another. These angular sections may have elongated holes, through which extensions of the roller axis engage as pivoting bearings. These angular sections may furthermore also have recesses which serve to lock the pivoting mount in the 90° position. The bulges are thus inserted via locking journals. The locking journal may be formed by a neck of a screw, which is thread-free in the locking region.

One exemplary embodiment of the invention is illustrated below using attached drawings.

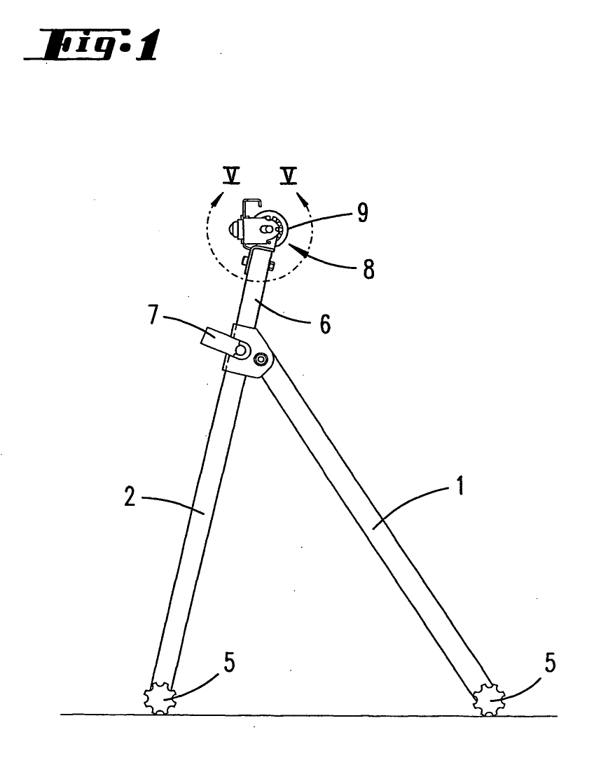

FIG. 1 shows the support trestle of the invention in elevation,

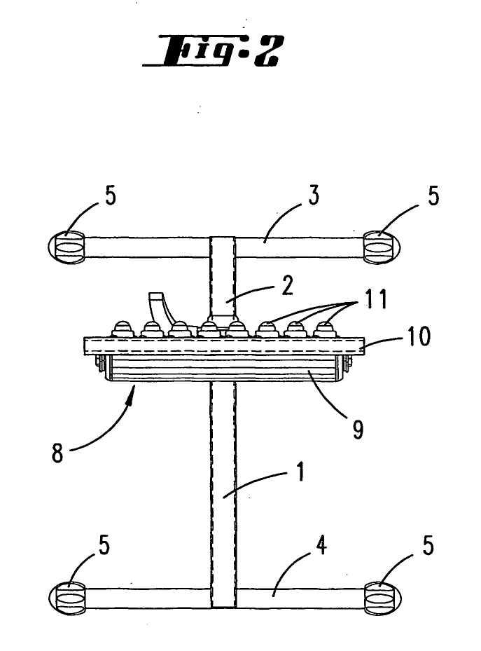

FIG. 2 shows the support trestle in plan view,

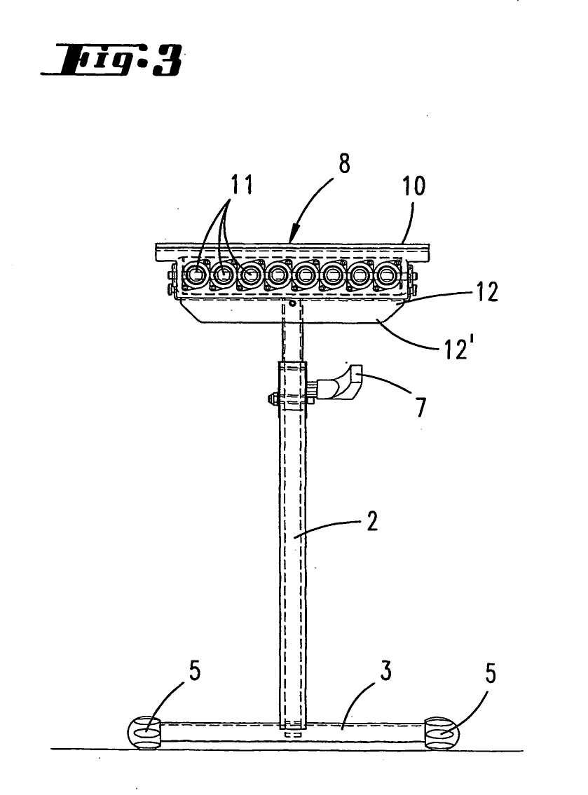

FIG. 3 shows the support trestle in side view,

FIG. 4 shows the support trestle in plan view with pivoted pivoting mount,

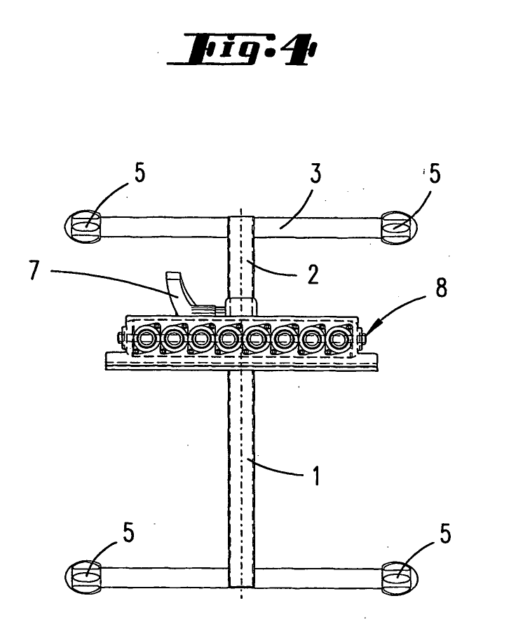

FIG. 5 shows an enlarged representation of the support head according to FIG. 1, with active flat bearing surface.

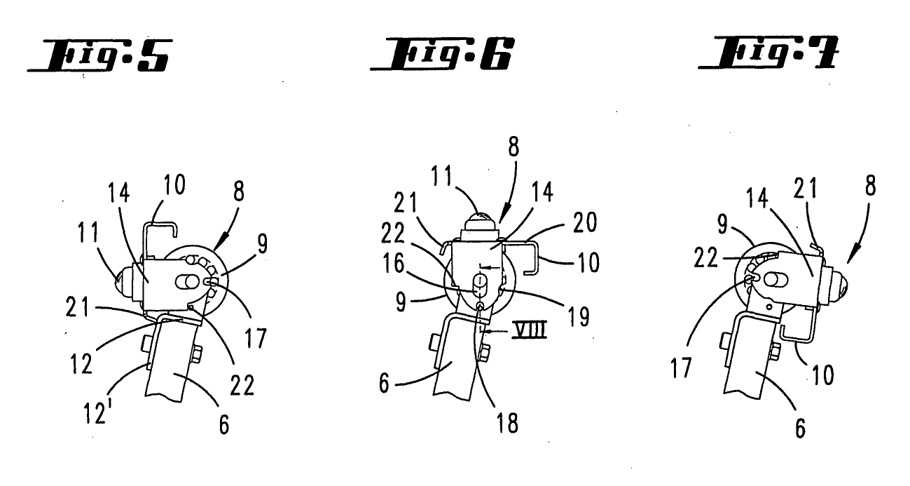

FIG. 6 shows a representation according to FIG. 5 with pivoting mount pivoted by 90°, wherein the bearing balls point upwards,

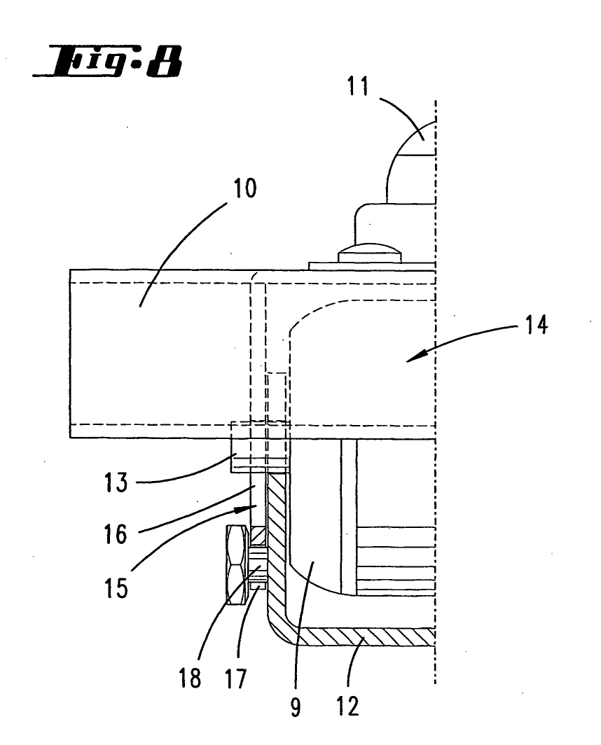

FIG. 7 shows a representation according to FIG. 5 with pivoting mount pivoted by about 180°, with non-active pivoting body,

FIG. 8 shows an enlarged representation of the section according to line VIII-VIII in FIG. 6.

The legs 1, 2 of the exemplary embodiment essentially have the shape of an inverted T, wherein the T-crosspiece forms in each case a transverse support 3, 4, on the ends of which end caps 5 sit, which form the feet of the support trestle.

The support trestle has a fixed leg 2, in which a support tube 6 is inserted, which can be telescoped out of the fixed leg 2 and which can be fixed in the different height positions by means of a clamping element 7. In the region of the clamping element 7, the second leg designed to be longer is pivotably articulated so that it may be brought from the stay position limited by a stop shown in the drawings into a parallel position to the fixed leg.

The support head 8 is screwed on the free end of the support tube 6. This support head 8 has a sheet metal strip made into a U shape which forms a roller support 12. This roller support 12 has a bend 12′, with which it is screwed to the end of the support tube 6. The U-shaped design of the roller support is used to mount the roller 9. The extensions forming the U shape have openings. The roller with its roller axis projections 13 is inserted in the openings of the U limb.

The two opposing roller axes 13 running in the horizontal plane are furthermore the pivoting bearings for a pivoting mount 14, which is articulated pivotably on the roller support 12. This pivoting mount 14 likewise has a U-shaped design and is also designed as a punched bent component. On the rear side of its surface area, the roller support 12 has in total 8 rotatably held balls 11 arranged in rows one behind another, the tops of which lie on a line, and which form a support element, on which a workpiece may be placed so that it may be displaced in all directions of the plane.

The base surface is continued on one side in an extension 20, which is continued in a 90° bend which forms a bearing surface. On the opposite side, the base surface is likewise continued in a stop extension 21, which kicks against the roller support 12 when the bearing surface 10 points upwards, so that the pivoting mount 14 is supported. This position is shown in FIG. 1 and in FIG. 5.

In the position shown in FIG. 6, the base surface of the pivoting mount 14 is directed upwards, so that the bearing balls 11 occupy their operational position. In this position, a recess 17, which is arranged in the intended extension of the elongated hole, covers a locking journal 18 assigned to the roller support 12. The locking journal 18 is formed by a thread-free neck section of a screw.

In the operational position shown in FIG. 7, the front of the roller 9 is in its operational position. The pivoting mount 15 is now pivoted back so far that the support extension 21 lies below the horizontal plane, which goes through the top of the roller. In this position, the pivoting mount 14 is likewise supported against the locking journal 18. The U-shaped extension of the pivoting mount 14 also having the recess 17 thus has a further recess 19.

A stop angle, which cooperates with the locking journal 18 in the position shown in FIG. 5, is situated opposite the recess 19. The stop angle thus engages behind the locking journal 18 in order to prevent displacement of the pivoting mount 14.

All disclosed features are (in themselves) essential to the invention. The disclosure content of the accompanying/attached priority documents (copy of the prior application) is thus also completely included in the disclosure of the application, also for the purpose of also incorporating features of these documents in claims of the present application.

1. Support trestle having a sub-frame (1 to 5) and a support head (8) supported to be height-adjustable on the latter, which support head (8) has a first support element which can be used as a workpiece support and is designed as a roller (9), and at least one further support member (10,11) which, in place of the roller (9), in the form of bearing balls (11) arranged in rows and used as workpiece support, can be brought into its operational position by providing a pivoting support (14) formed by the support head (8), characterised in that the pivoting support (14) having the further support member can be pivoted about extensions of the roller axis (13) and with an angular extension of the section of the pivoting support (14) designed as a punched and bent part carrying the bearing balls (11) forms a second further support member in the form of a flat bearing surface (10) which through pivoting the pivoting support (14) can be brought into its operational position.

2. Support trestle according to claim 1, characterised in that the pivoting support (14) locks in its operational position.

3. Support trestle according to one or more of the preceding claims or in particular thereafter, characterised in that the one further support element (10) occupies its operational position in an approximately 90° pivoting position with respect to the roller operational position and the other further support element (11) in an approximately 180° pivoting position.

4. Support trestle-according to one or more of the preceding claims or in particular thereafter, characterised in that two angular sections (15) of the punched and bent part have elongated holes (16), through which the extensions of the roller axis (13) engage.

5. Support trestle according to claim 4, characterised in that the angular sections (15) have in each case a recess (17), which can be inserted via a locking journal (18) to lock the pivoting support in the 90° position.

6. Support trestle according to claim 5, characterised in that the locking journal (18) is formed by the threading free neck of a screw.
